(19) United States
(12) Patent Application Publication
(10) Pub. No.: US 2014/0224244 A1
(43) Pub. Date: Aug. 14, 2014

(54) HEATING ELEMENT, AN ELECTRONIC CIGARETTE AND A METHOD FOR FORMING THE HEATING ELEMENT

(71) Applicant: Qiuming Liu, Shenzhen (CN)

(72) Inventor: Qiuming Liu, Shenzhen (CN)

(21) Appl. No.: 13/893,772

(22) Filed: May 14, 2013

(30) Foreign Application Priority Data
Feb. 8, 2013 (CN) 201310050245.0

(51) Int. Cl. H05B 1/02; H01C 17/16; A24F 47/00; H05B 3/14

(52) U.S. Cl. CPC H05B 1/0288; H05B 3/14; H01C 17/16; A24F 47/008
USPC 128/202.21; 219/542; 219/553; 29/611

(57) ABSTRACT

A heating element, electronic cigarette and method for forming heating element. The heating element includes a heating part and a connection part extending along both ends of the heating part so as to form a first connection end and a second connection end, which are electrically connected to a drive circuit respectively. The first connection end, the second connection end and the heating part are integrative, and the first connection end and the second connection end both has a coating covered on outer surface of them respectively. The heating element is integrated designed without any complex technique of the welding or riveting, and via electroplating to form a coating on the heating element instead, the production efficiency of the heating element gets highly improved, costs reduced and a stable resistance value gets obtained in the mass-produced heating elements, involving a consistency in mass production.

### CROSS-REFERENCE TO RELATED APPLICATIONS

This non-provisional application claims priority under 35 U.S.C. §119(a) on Patent Application No. 201310050245.0 filed in P.R. China on Feb. 8, 2013, the entire contents of which are hereby incorporated by reference.

### FIELD OF THE INVENTION

The present invention relates to technical field of smoking set, more particularly to a heating element, an electronic cigarette using the heating element and a method for forming the heating element.

### BACKGROUND OF THE INVENTION

The heating element of an electronic cigarette comprises a heating part generally made of high resistivity alloy heating components (such as nicochrome, aludirome and constantan alloy) and a connection part for heating after electrified to atomize the cigarette fluid so as to generate smoking effect. The Connection part of a heating element is used for being electrically connected to drive circuit. The connection part is generally made of copper conductor and can be connected to the heating part via welding or riveting. For example, FIG. 1 illustrates that heating part 1 and connection part 2 are riveted, while FIG. 2 illustrates that heating part 1 and connection part 2 are welded. Besides, in the Chinese patent, application No. 201020280861.7, named “a heating device for electronic cigarette,” the heating wire (equaling the heating piece) and the conducting wire (equaling the interconnecting piece) are riveted together.

However, the aforementioned welding or riveting connection involves a complicated processing of heating element, and an unstable resistance value of the heating element in mass production. Moreover, the welding position of the heating elements by welding is easy to be oxidized and the contact resistance value of the heating element's weld is comparatively high.

### SUMMARY OF THE INVENTION

Aiming at the drawbacks of the heating element in the electronic cigarette in the prior art of complex processing technique and unstable resistance, the objective of the present invention is to provide a heating elements, electronic cigarette and method for forming the heating element.

To solve the technical problem, the invention provided a heating element, comprising a heating part and a connection part extending along each end of the heating part so as to generate the first connection end and a second connection end which are electrically connected to the drive circuit, wherein the first connection end, the second connection end and the heating part are integrated, the first connection end and the second connection end are provided with a coating with low resistivity covered on their outer surfaces respectively.

In the heating element of the present invention, the heating part, the first connection end and the second connection end are made of alloy material with circular cross section, the first connection end and the second connection end extend in axial direction along each end of the heating part respectively with the same extending distance or different extending distances and are set to be located on corresponding end of the spiral heating part, the coating extends outward in radical direction of the first connection end and the second connection end so as to forming an evenly coverage of the coating on the first connection end and the second connection end, and the dimension of the cross section between the heating part and the first connection end is the same with that of the cross section between the heating part and the second connection end.

In the heating element of the invention, the heating part, the first connection end and the second connection end are all in shape of strip with cross section of polygon and made of linear alloy material, the first connection end and the second connection end extend horizontally along each end of the heating part with the same extending distance or different extending distances and get mounted on to the corresponding end of the spiraled heating part, the coating extends outward in radical direction of the first connection end and the second connection end so as to generate an even coverage of the coating, and the dimension of the cross section between the heating part and the first connection end is equal to that of the cross section between the heating part and the second connection end.

In the heating element of the invention, the heating part comprises one of a plurality of the alloys including nicochrome, economet, aludirome and constantan alloy.

In the heating element of the invention, the coating comprises one of the materials of gold, silver, cuprum or tin.

In the heating element of the invention, the coating is made of alloy having low resistivity.

An electronic cigarette is also provided in the present invention, wherein the heating element claimed in the invention is mounted in the atomizer chamber of the electronic cigarette.

The invention also disclosed a method for forming the heating element, comprising procedures as follows:

A) Integrated forming the heating part and the connection part comprising a first connection end and a second connection end, both extending along each end of the heating part;

B) Plating a coating with low resistivity respectively on the outer surfaces of the first connection end and the second connection end;

C) Connecting the first connection end and the second connection end with drive circuit respectively;

In the method for forming the heating element, the procedure further comprises:

A1) selecting alloy materials with high resistivity;

A2) cutting the selected alloy materials into pieces;

A3) dividing the cut alloy material pieces into areas including the heating part, the first connection end and the second connection end, with the first connection end and the second connection end set onto each end of the heating part respectively.

In the method for forming the heating element, the procedure B further comprises:

B1) electroplating the first connection end and the second connection end by using materials with low resistivity, forming a coating with even coverage on outer surfaces of the first connection end and the second connection end;

B2) curling the electroplated alloy material, making the heating part in spiral shape, and making the first connection end and the second connection end correspondingly set on each end of the spiral heating part respectively, with the distance between the first connection end and the corresponding end of the spiral heating part is equal to/or different from the distance between the second connection end and the corresponding end of the spiral heating part.

Implementing the invention, following advantages may be obtained that, the heating element of the invention is integrated designed without any complex technique of welding or riveting. The coating is formed via electroplating, thus greatly improving the production efficiency of the electronic cigarette and saving the cost, and a stable resistance value gets obtained in the mass-produced heating elements, involving a consistency in mass production. Further because the coating is formed by metal or alloy with low resistance, the connection part of the heating element involves a fairly low resistance value.

### BRIEF DESCRIPTION OF THE DRAWINGS

FIG. 1 is a schematic diagram of riveting connection between the heating part and the connection part in the prior art;

FIG. 2 is a schematic diagram of welding connection between the heating part and the connection part in the prior art;

FIG. 3 is a structural diagram for the heating element in a preferred embodiment of the invention;

FIG. 4 is a structural diagram of the heating element before curling;

FIG. 5 is a structural diagram of the heating element before electroplating;

FIG. 6 is a structural diagram in another embodiment of the invention;

FIG. 7 is a structural diagram for the electronic cigarette in the invention.

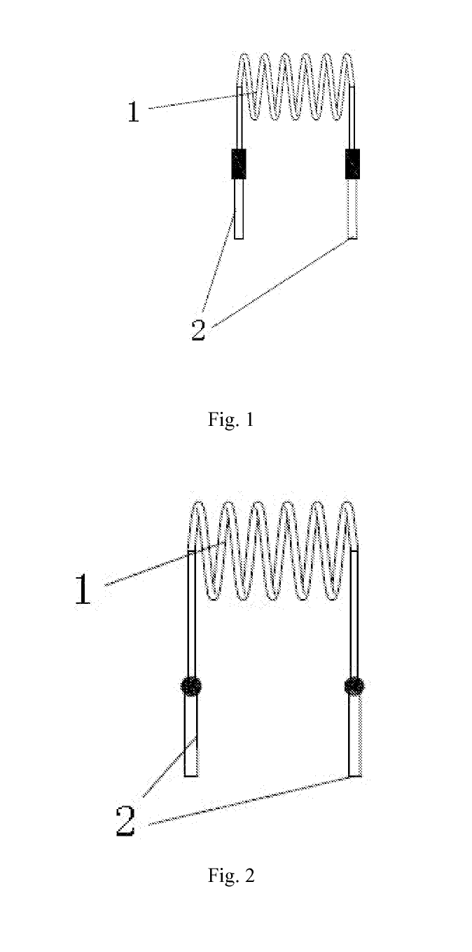

### DETAILED DESCRIPTION OF THE PREFERRED EMBODIMENT

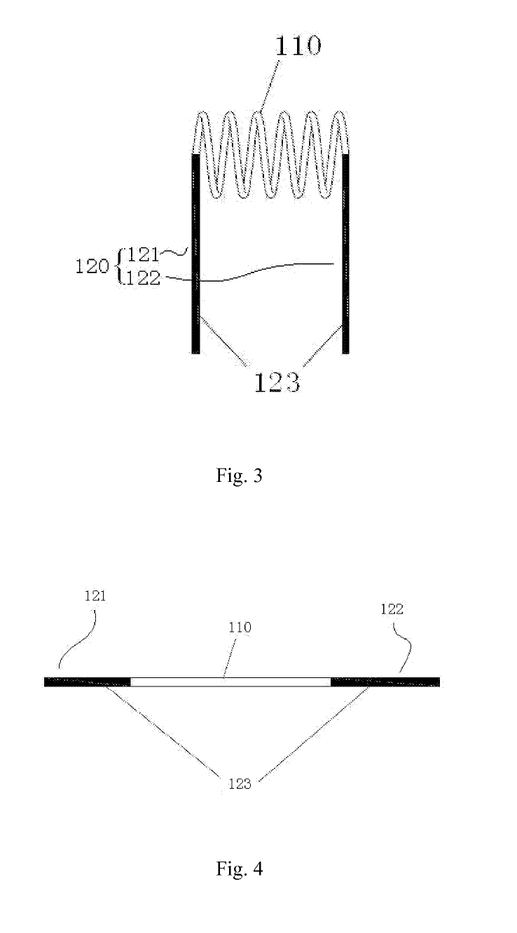

Referring to FIG. 3, the present invention provides a heating element 100 including a heating part 110 and a connection part 120 extending along both ends of the heating part 110 so as to form a first connection end 121 and a second connection end 122, wherein heating part 110 is electrically connected to drive circuit (not shown) for transmitting electrical energy to the heating part 110, and the heating part 110 is for atomizing cigarette fluid after getting electrified. The first connection end 121 and the second connection end 122 respectively have a coating 123 covering around outer surfaces of the connection ends 111-122, and the coating 123 is formed by electroplating pure metal or low resistivity alloy having low resistivity.

In the present invention, the heating part 110, the first connection end 121 and the second connection end 122 are integrative and made of the same high resistivity alloy materials, for instance, nico chrome, economet, aludirome and constantan alloy, such as constantan alloy 6J40 and Cr20Ni80.

In the present embodiment, all of the heating part 110, the first connection end 121 and the second connection end 122 are filamentous, and preferably, are made of wire stock of the same material. The heating part 110 is curled to be in spiral shape, and the first connection end 121 and the second connection 122 end are formed, extending at both ends of the heating part 110.

Specifically, in the preferred embodiment of the heating element in the invention, the heating part 110, first connection end 121 and second connection end 122 are made of alloy materials and having circular cross section, wherein the first connection end 121 and the second connection end 122 extend along each end of the heating part 110 respectively in axially direction with an equal extending distance or different extending distances (there are two instance for the aforementioned different distances: one is that the extending distance of first connection end 121 is larger than that of that of second connection end 122; the other is that the extending distance of the second connection end 122 is larger than that of the first connection end 121) and correspondingly are set on each end of the spiraled heating part 110, the coating 123 extends outwardly in the radical direction of the first and second connection ends 121-122 so as to foming an evenly coverage of the coating 123, and the dimension of the cross section between the heating part 110 and the first connection end 121 is equal to that of the cross section between the heating part 110 and the second connection end 122.

The coating 123 is formed by electroplating materials with low resistivity, comprising low resistive metals such as gold, silver, copper and tin, or alloys such as colomony and lanthanum aluminium alloy, while in the present invention it is disclosed that the material shall has a resistivity less than 2.5×10-8 Ω. The resistance value of the connection part 120 is very low for the coating 123 with low resistivity plated on the connection part 120. Referring to FIGS. 3-4, the coating 123 can be electroplated before the heating element 100 is curled. In the embodiment, the whole outer surface of the first connection ends 121-122 are covered by the coating 123.

In a preferred embodiment of the invention, outer surfaces of the first connection ends 121-122 are covered by the coating 123 evenly with the same thickness on both of the connection ends 121-122. The welding position of the coating 123 and drive circuit (not shown) is not fixed, thus advantageously making contact resistance between the connection part 120 and drive circuit steady, and even when the coating is welded to the drive circuit at different positions, the contact resistance between the connection part 120 and the drive circuit is still maintained the same.

The shape of the heating element 100 is not limited in the invention that the heating element 100 may be in shape of filament, flake or strip, or having cross section of circle, ellipse, polygon(including triangle and rectangle) or any other geometry shapes, as is shown in FIG. 6 that the heating element 100 comprises a heating part 110, first connection end 121 and second connection end 122, all of which are in flake structure, and the coating 123 is covered on the first and second connection ends 121-122.

Further, in other embodiments of the heating element in the invention, the heating part 110, the first connection end 121 and the second connection end 122 may be in shape of strip with a polygonal-shaped cross section (including rectangle, triangle and hexagon) and made of alloy material, wherein, the first connection end 121 and the second connection end 122 extend horizontally along the each end of the heating part 110 with the same extending distance or two different extending distances (there are two instance of the different extending distances: one is that the extending distance of the first connection end 121 is larger than that of the second connection end 122, and the other is that the extending distance of the second connection end 122 is larger than that of the first connection end 121) and get mounted on to the corresponding end of the spiraled heating part 110, the coating 123 extends outwardly around the outer surfaces of the first and second connection ends 121-122 so as to to forming an even coverage of the coating 123, and the dimension of the cross section between the heating part 110 and the first connection end 121 is equal to that of the cross section between the heating part 110 and the second connection end 122.

The present invention also discloses an electronic cigarette using the heating element 100 in the above-mentioned embodiments. Specifically, the electronic cigarette comprises a cigarette holder 200, cigarette pipe 300 and the lamp cap 310 mounted on one end of the cigarette pipe 300. A battery 320 is mounted in the cigarette pipe 300. Other structure features of the electronic cigarette will not be discussed in this instance.

An atomizer chamber 210 is mounted in the cigarette holder 200 having a cigarette holder cap 220 located on one end of it, and the heating element 100 is mounted in the atomizer chamber 210, on the side facing toward cigarette holder cap 220, while the connection part 120 is mounted in the atomizer chamber 210 on the side facing the battery 310. Both ends of the connection part 120 is electrically and welded to get connected to the drive circuit respectively on both ends. Drive circuit and the battery 310 are electrically connected. It is comparatively easy to weld the connection part 120 to other parts of the electronic cigarette, for the coating 123 covered on the connection part 120.

The invention also discloses a method for processing heating element in the electronic cigarette, wherein the method comprises procedures as follows:

Integrated forming the heating part 110 and the connection part 120, wherein the connection part 120 comprises the first connection end 121 and the second connection end 122, both of which extend along each end of the heating part 110;

Plating a coating 123 with low resistivity respectively on outer surfaces of the first and second connection ends 121-122;

Connecting the first and second connection ends 121-122 respectively to drive circuit of the electronic cigarette via welding, riveting or connection terminals or fasteners, wherein the specific connecting ways belong to customary means in the art and the specified description won't be given accordingly.

Specifically, the method for processing the heating element in the electronic cigarette shall be further explained in accordance with the preferred embodiment of the invention, the processing method comprising procedures as follows:

S1, selecting alloy materials with high resistivity, including nicochrome, economet, aludirome and constantan alloy, most of which are standard wire stock in various shapes of filament or flake, for example, the alloy materials possibly being constantan alloy 6J40 or Cr20Ni80, etc ;

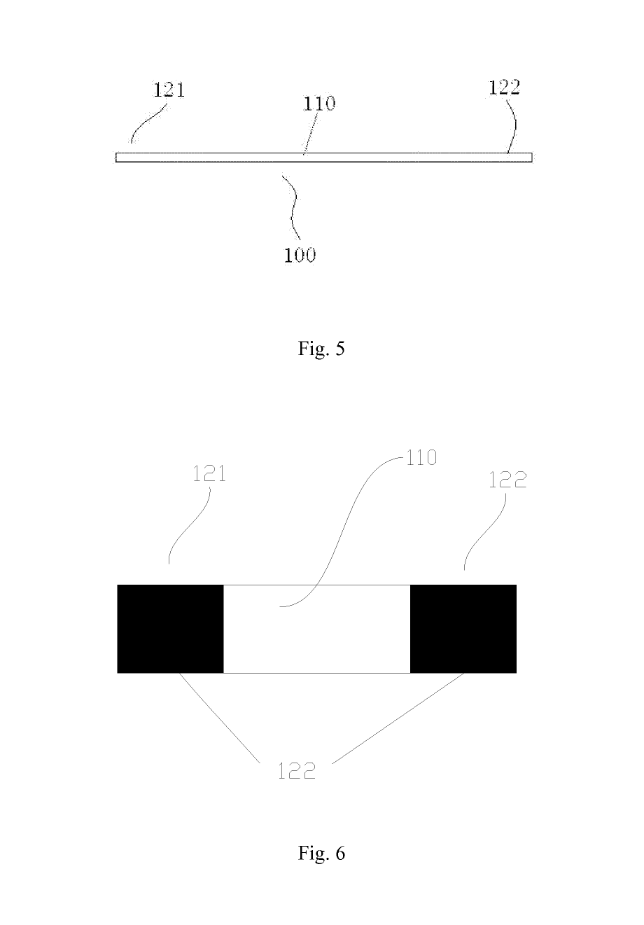

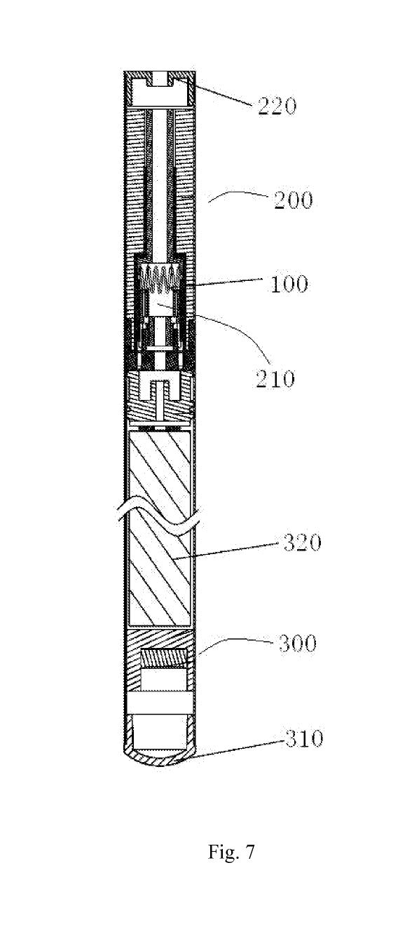

S2, cutting the selected alloy materials, making the cut alloy material pieces has the length equal to the length of the heating element 100 before curled, as shown in FIG. 5;

S3, dividing the cut alloy material pieces into the heating part 110, the first connection end 121 and the second connection end 122, electroplating a coating 123 on the outer surfaces of the first connection end 121 and the second connection end 122.

S4, curling the electroplated alloy material, making the heating part 110 in spiral shape, and making the first connection end 121 and the second connection end 122 correspondingly set on each end of the spiral heating part respectively, with the distance between the first connection end 121 and the corresponding end of the spiral heating part 110 equal to the distance between the second connection end 122 and the corresponding end of the spiral heating part 110.

S5, connecting the heating element 100 to drive circuit of electronic cigarette via welding or some other way.

When implementing the processing method of the heating element in the present invention, the followed advantages can be obtained: the heating element 100 comprises a stable resistance value and a consistency in mass production; the coating 123, first connection end 121 and the second connection end 122 are integrated designed, without any complex technique of welding or riveting. The coating 123 is formed via electroplating of fine metal or metal alloy of low resistivity, thus connection part 120 having extremely low a resistance value. Thanks to the coating 123 on the connection part 120, to weld the connection part 120 with other parts (such as the drive circuit) of the electronic cigarette gets comparatively easy. As electroplating belongs to mature proscesses, the processing of heating element in this invention may improve the production efficiency of the electronic cigarette beltline and save the productive cost of electronic cigarette.

It should be understood for one skilled in the art that various changes and modifications or alternation should made in accordance with aforementioned description and should fall into the scope of the appended claims in the present invention.

What is claimed is:

1. A heating element including a heating part and a connection part extending along both ends of the heating part so as to generate a first connection end and a second connection end which are electrically connected to the drive circuit respectively, characterized in that the first connection end, the second connection end and the heating part are integrated, and the first connection end and the second connection end are provided with a coating with low resistivity, covering on their outer surfaces.

2. The heating element of claim 1, wherein the heating part, the first connection end and the second connection end are made of alloy material, with circular cross section, the first connection end and the second connection end extend along both ends of the heating part in axial direction respectively with the same extending distance or different extending distances and are set on corresponding ends of the spiral heating part, the coating extends outward in radical direction of the first connection end and the second connection end so as to forming an evenly coverage of the coating on the first connection end and the second connection end, and the dimension of the cross section between the heating part and the first connection end is equal to that of the cross section between the heating part and the second connection end.

3. The heating element of claim 1, wherein the heating part, the first connection end and the second connection end are all in shape of strip with cross section of polygon and made of linear alloy material, the first connection end and the second connection end extend horizontally along each end of the heating part with the same extending distance or different extending distances and get mounted on to the corresponding end of the spiraled heating part, the coating extends outward in radical direction of the first connection end and the second connection end so as to generate an even coverage of the coating, and the dimension of the cross section between the heating part and the first connection end is equal to that of the cross section between the heating part and the second connection end.

4. The heating element of claim 1, wherein the heating part comprises one of a plurality of alloys including nicochrome, economet, aludirome and constantan alloy.

5. The heating element of claim 4, wherein the coating comprises one of the materials of gold, silver, cuprum or tin.

6. The heating element of claim 4, wherein the coating is made of alloy having low resistivity.

7. An electronic cigarette, wherein the heating element claimed in claim 1 is mounted in the atomizer chamber of the electronic cigarette.

8. A method of forming heating element, characterized in that the method comprises procedures as follows:
A) Integrated forming the heating part and the connection part comprising a first connection end and a second connection end, both extending along each end of the heating part;
B) Electroplating a coating with low resistivity respectively on the outer surfaces of the first connection end and the second connection end;
C) Connecting the first connection end and the second connection end with drive circuit respectively.

9. The method of forming heating element of claim 8, wherein the procedure A further comprises:
A1) Selecting alloy materials with high resistivity;
A2) Cutting the selected alloy materials into pieces;
A3) Dividing the cut alloy material pieces into areas including the heating part, the first connection end and the second connection end, with the first connection end and the second connection end set onto each end of the heating part respectively.

10. The method of forming heating element of claim 9, wherein the procedure B further comprises:
B1) electroplating the first connection end and the second connection end by using materials with low resistivity, forming a coating with even coverage on outer surfaces of the first connection end and the second connection end;
B2) curling the electroplated alloy material, making the heating part in spiral shape, and making the first connection end and the second connection end correspondingly set on each end of the spiral heating part respectively, with the distance between the first connection end and the corresponding end of the spiral heating part is equal to/or different from the distance between the second connection end and the corresponding end of the spiral heating part.
